(19) United States
(12) Patent Application Publication
(10) Pub. No.: US 2004/0113025 A1
(43) Pub. Date: Jun. 17, 2004

(54) Pipe supporting devices

(76) Inventor: Nathan M. Sargent, Coalville, UT (US)

Correspondence Address: KENNETH E. HORTON, KIRTON & MCCONKLE, 60 EAST SOUTH TEMPLE, SUITE 1800, SALTLAKE CITY, UT, 84111, US

(21) Appl. No.: 10/317,392

(22) Filed: Dec. 11, 2002

(51) Int. Cl. F16L 3/00

(52) U.S. Cl. 248/49; 248/65; 248/55

(57) ABSTRACT

Pipe supporting devices that receive and supports a pipe, especially a pipe exposed on a horizontal surface like a roof. The device has a base with a substantially flat bottom for resting on the horizontal surface and a supporting structure rising from the base to support the pipe. The supporting structure comprises a horizontal rod that is connected between vertical supports using a looped bracket. The looped bracket can be quickly and easily made. Positioning means can be provided on the horizontal rod to position and center the pipe between the vertical supports.

### FIELD OF THE INVENTION

The invention relates to devices for supporting pipes. In particular, the invention relates to devices for supporting pipes on horizontal surfaces, such as exterior pipes on roofs. Even more particularly, the invention relates to brackets used in such pipe supporting devices.

### BACKGROUND OF THE INVENTION

Pipes often run along the roofs in buildings, including commercial buildings, for various purposes such as connecting air conditioning units or other service units that are mounted on the roof. These pipes are often supported above the horizontal surface at intervals along their length by placing supporting mechanisms, like blocks of wood, between the horizontal surface and the pipes. When the temperature changes, the pipes expand and contract and often the wood block moves with pipe because, in part, of the large contact surface area between the block and the pipe. Eventually, movement of the block against the roof combined with the weight of the pipe on the wood block causes damage to the roof, resulting in leaks and requiring expensive roof repair. Even if the wood blocks are nailed to the roof, the nails and the wood can deteriorate and the blocks can break loose.

Various types of other pipe supporting mechanisms are known in the art. See, for example, U.S. Pat. Nos. 5,906,341, 5,871,306, 5,102,073, 5,028,019, 5,028,149, 5,685,608, 4,502,653, 4,513,934, and 5,829,718, the disclosures of which are incorporated herein by reference. Some of these pipe-supporting mechanisms have a substantially flat-bottomed base and a pipe supporting structure rising from the base that distributes the weight of the pipe over the base and, therefore, over the area of the roof in contact with the base.

There are numerous types of pipe supporting structures for supporting pipes on such types of bases. One common type of such structures supports the pipe on a horizontal rod that is connected between vertical supports using a connector. See, for example, U.S. Pat. Nos. 2,103,811, 5,934,626, and 6,364,256, the disclosures of which are incorporated herein by reference.

There are several problems, however, with this configuration of pipe supporting structures. One problem is that connector can be expensive, especially where the vertical supports are threaded. Another problem is that its mechanical strength is limited for its weight. Finally, the connector can—to a degree—swivel around the vertical supports.

### SUMMARY OF THE INVENTION

The invention comprises a device or apparatus that receives and supports a pipe, especially a pipe exposed on a horizontal surface like a roof. The device has a base with a substantially flat bottom for resting on the horizontal surface and a supporting structure rising from the base to support the pipe. The supporting structure comprises a horizontal rod that is connected between vertical supports using a looped bracket. The looped bracket can be quickly and easily made. Positioning means can be provided on the horizontal rod to position and center the pipe between the vertical supports.

The invention includes a device for supporting a pipe containing a base, two vertical supports extending upward from the base, a horizontal shaft located between the vertical supports, and means for connecting the horizontal rod and the vertical supports, the connecting means comprising a looped bracket. The invention also includes a device for supporting a pipe containing a base, two vertical supports extending upward from the base, a horizontal shaft located between the vertical supports, and a looped bracket at each end of the horizontal shaft for connecting the horizontal shaft to each vertical support. The invention further includes a device for supporting a pipe containing a base containing a plurality of flanges, two vertical supports extending upward from the base and supported by the plurality of flanges, a horizontal shaft located between the vertical supports and a looped bracket at each end of the horizontal shaft for connecting the horizontal shaft to each vertical support.

The invention also embraces a method for supporting a pipe by providing a pipe, then providing a device containing a base, two vertical supports extending upward from the base, a horizontal shaft located between the vertical supports, and means for connecting the horizontal rod and the vertical supports, the connecting means comprising a looped bracket, and then placing the pipe on the horizontal shaft between the vertical supports.

### BRIEF DESCRIPTION OF THE DRAWINGS

FIGS. 1-5 are views of one aspect of the pipe supporting devices and methods of using such devices according to the invention, in which:

FIG. 1 illustrates one use of a pipe supporting device in one aspect of the invention;

FIGS. 2-3 illustrates a pipe supporting device in one aspect of the invention;

FIG. 4 depicts a pipe supporting device in another aspect of the invention; and

FIG. 5 depicts a connector for a pipe supporting device in one aspect of the invention.

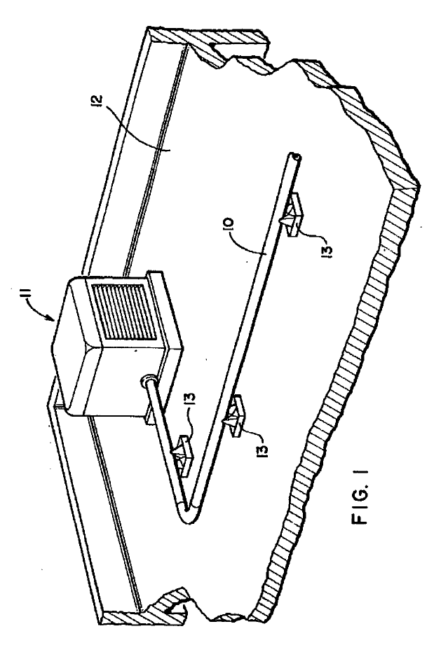

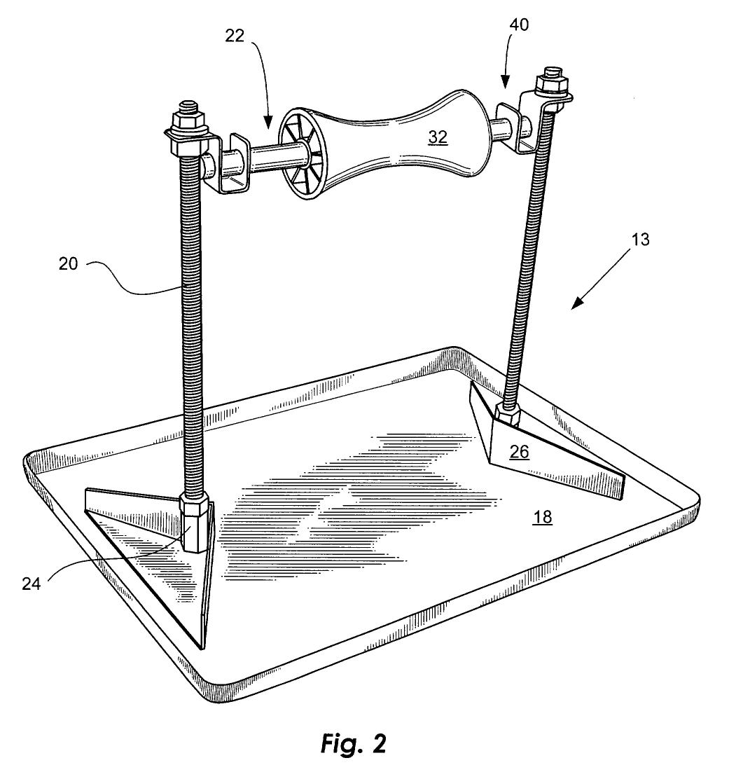

FIGS. 1-5 presented in conjunction with this description are views of only particular-rather than complete portions of the pipe supporting devices and methods of using the devices according to the invention. Together with the following description, the Figures demonstrate and explain the principles of the invention.

### DETAILED DESCRIPTION OF THE INVENTION

The following description provides specific details in order to provide a thorough understanding of the invention. The skilled artisan, however, would understand that the invention can be practiced without employing these specific details. Indeed, the present invention can be practiced by modifying the illustrated system and method and can be used in conjunction with apparatus and techniques conventionally used in the industry. Indeed, the invention could be employed in other applications, such as supporting pipes on any substantially horizontal surface, not merely on a roof.

It is common in buildings to have pipes supported above the roof. FIG. 1 shows a common installation for pipe 10 that extends from a service unit 11 (such as an air conditioning unit) across the roof 12 to a location (not shown) over the side of the roof, through the roof, or is connected to other roof-mounted equipment such as other service units. At least one pipe supporting device 13 of the invention is placed on the roof to cradle and support pipe 10 as it extends along the roof.

The number of pipe supporting devices 13 needed to properly support the pipe depends on several factors. Such factors include the type of pipe used, the size of the pipe, the weight of the pipe, the material of the pipe, the configuration of the pipe on the roof, as well as the material and configuration of the pipe-supporting devices.

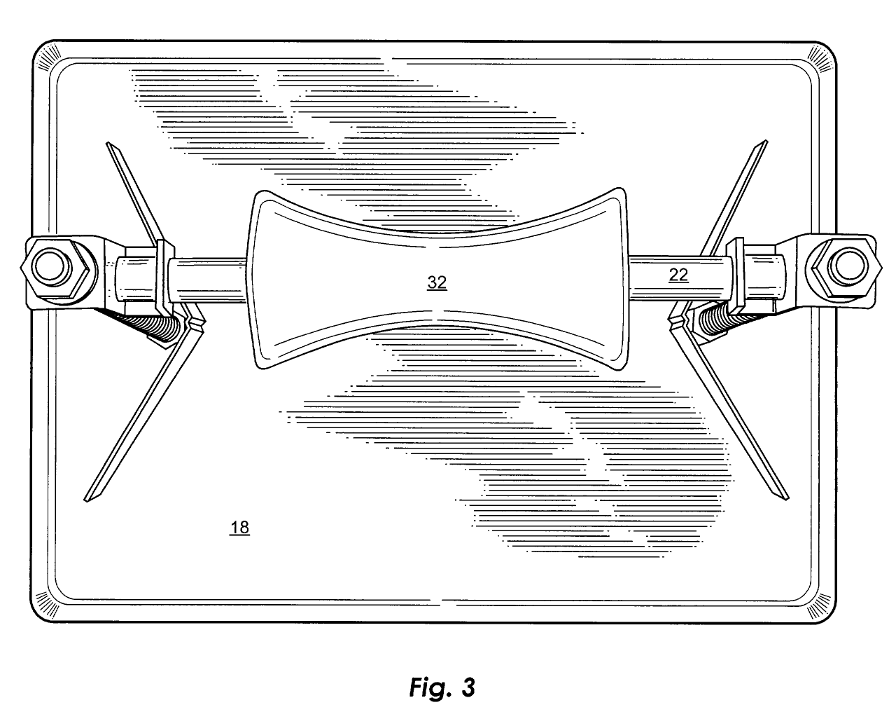

FIGS. 2-5 illustrate several aspects of the pipe-supporting device 13 of the invention. As shown in FIG. 2, each pipe-supporting device 13 includes a base 18. Base 18 of pipe-supporting device 13 can be of any suitable configuration known in the art. Suitable configurations include those evenly distributing the weight of the pipe such as round, triangular, rectangular, square, hexagonal, octagonal, etc. As known in the art, base 18 can optionally serve as a pitch pan for holding pitch that is poured therein to act as a sealant for nails or screws that are used to connect base 18 to roof 12.

The size of base 18 can be any size providing the needed structural integrity for device 13. The dimension of base 18 can be large enough to spread the weight of any pipe supported over a portion of a building roof sufficient to safely support such weight without damage to the roof. In one aspect of the invention, a dimension of about 12 inches by about 16 inches can be used in the invention.

The pipe-supporting device 13 of the invention provides substantially even distribution of the pipe weight over base 18. The bottom of base 18, therefore, should be configured in any desired manner to maximize support for the pipe supporting device. In one aspect of the invention, the bottom of base 18 can be configured to provide maximum surface area between base 18 and roof 14. In another aspect of the invention, the bottom of base 18 is configured with a portion thereof being substantially flat. The substantially flat area can be maximized, thereby minimizing the pipe weight per unit area of base 18.

Extending upward from base 18 is at least one pair of vertical supports 20. In the aspect of the invention depicted in FIG. 2, there is single pair of vertical supports. In other aspects of the invention, however, there can be two or more pair of vertical supports. Using more than a single pair of vertical supports allows better distribution of the weight of the pipe over the base 18.

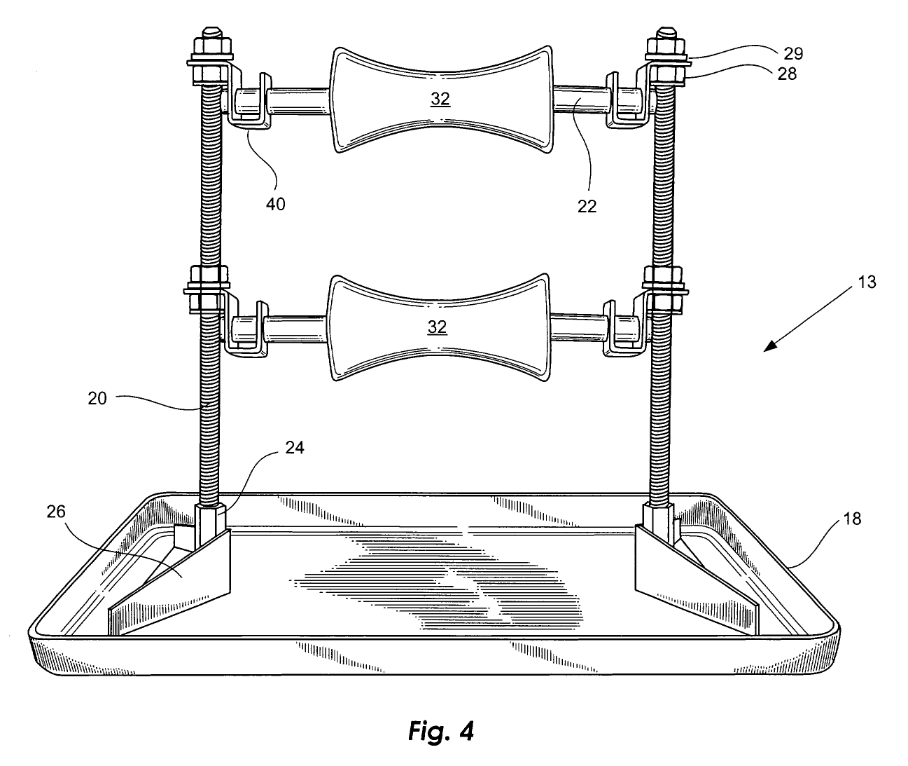

The vertical supports 20 can be any length necessary to support the pipe 10. In the aspect of the invention depicted in FIG. 2, the length is sufficient to support a single pipe. In other aspects, however, the vertical supports can be made longer to support additional pipes in a vertical direction as depicted in FIG. 4. The number of pipes that can be supported (and therefore the length of the supports) depends largely on the mechanical limitations of the vertical supports.

The vertical supports 20 can take any form that provides the desired support to the horizontal shaft or rod 22. In one aspect of the invention, the vertical supports 20 have the form of threaded rods as shown in FIG. 2. The vertical supports generally extend upwardly from the base in a substantially parallel configuration. The vertical supports are typically spaced apart by a width sufficient so the pipe will not abut the vertical supports (but this width depends on the dimensions of the base 18 and the pipe diameter).

The base 18 is configured to include a pair of mounting holes 24 to receive the vertical supports 20. The mounting holes 24 serve to connect—and in certain aspects affix—the vertical supports 20 to the base 18. Where the vertical supports are threaded, the mounting holes 24 can have an opposing, but matching, thread.

The vertical supports 20 and mounting holes 24 can, in turn, be supported by a supporting mechanism. The supporting mechanism serves to support the vertical supports and mounting holes and distribute the weight of the pipe more evenly. Any supporting mechanism serving this function can be used in the invention. In one aspect of the invention, flanges 26 are used as the supporting mechanism.

The flanges 26 can be configured (in terms of number, shape, size, etc.) in any manner that provides the maximum amount of support. In one aspect of the invention, the flanges are configured as depicted in FIG. 2. Other configurations that can be used in the invention include those described in U.S. Design Pat. Nos. D466,393 and D466,394, the disclosures of which are incorporated herein by reference.

Connected to the vertical supports is horizontal shaft 22 on which the pipe rests. In one aspect of the invention, the horizontal shaft 22 has a cylindrical shape with a substantially circular cross section. The shaft is constructed of any suitable material known in the art. Suitable materials include those minimizes friction and resistance between the shaft and the sleeve, such as steel, stainless steel, or plastic materials.

In one aspect of the invention, positioning means can be located on the horizontal shaft 22. The positioning means serves several functions, including supporting the pipe 10 and allowing it to move in the pipe's axial direction. The positioning means also helps distribute the weight of the pipe. Importantly, the positioning means also positions the supported pipe in a transverse direction between the vertical supports.

In one aspect of the invention, the roller 32 illustrated in FIG. 2 is employed as the positioning means in the invention. Roller 32 is rotatably positioned on shaft 22, and can be configured to provide maximum support to the pipe when the pipe supporting device 13 is placed on substantially horizontal. The height of roller 32 can be adjusted to equalize the weight of the pipe when supported between a plurality of the supporting devices 13. Where there are more than one horizontal shaft (in either the horizontal or vertical direction), each shaft 22 can—but need not—contain a roller 32. See, for example, FIG. 2 of U.S. Pat. No. 6,364,256.

Roller 32 may be formed of a single piece. In one aspect of the invention, the roller 32 is formed of two roller halves 33 and 34 containing tabs 35 and mating tab receiving recesses 36, as described in U.S. Pat. No. 6,364,256. In one aspect of the invention, roller 32 can be configured to have a constant diameter throughout its length. In another aspect of the invention, however, the shape of roller 32 should be configured to accommodate the shape and size of the pipe, e.g., the shape of the roller 32 can be a substantially u-shape or curvilinear shape. The angle of incline of the u-shape or curvilinear shape can be modified for the size and shape of the pipe as well as for the structural integrity of roller 32. The roller 32 can have a small diameter in the middle that tapers to a larger diameter at the end, as illustrated in FIG. 3. The specific smaller and larger diameters, as well as the degree of the taper, depend on the size of the pipe to be supported.

The roller 32 is constructed from any suitable material known in the art. Suitable materials include those that are resilient enough to not be deformed by the pipe yet which minimize friction. Suitable materials include plastic materials, such as polycarbonate, Teflon, or glass-filled nylons. Preferably, polycarbonate resin is employed as the material for the sleeve.

The ends of horizontal shaft 22 can held in place by any suitable restricting means. The restricting means insure that the shaft 22 (and consequently roller 32) are fixed relative to the vertical supports. Any suitable mechanism serving such a function can be used in the invention. In one aspect of the invention (illustrated best in FIG. 4), nuts 28 and conforming washers 29 are used. Nuts 28 are threaded onto the vertical supports above and below horizontal shaft 25 and washers 29 are positioned between nuts 28 and shaft 25. The restricting means can be rotated to move them up or down on vertical supports 20 to adjust the position of shaft 25.

The pipe supporting device 13 of the invention also contains connecting means between the horizontal shaft 25 and the vertical supports. Any connecting means that provides such a function can be used in the invention, such as T connectors or brackets. In one aspect of the invention, a looped bracket can be used in the invention. The term “looped bracket” is used in the invention to mean any connection means that contains a loop for the vertical support as well as a plurality of loops for the horizontal shaft 22.

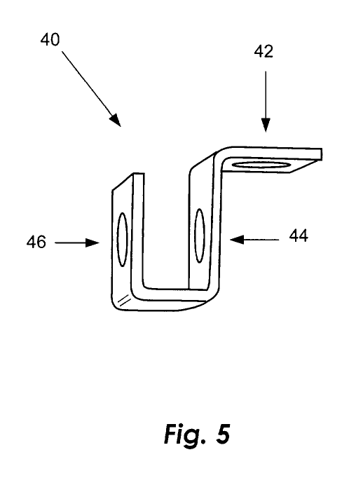

In one aspect of the invention, the looped bracket 40 depicted in FIG. 5 is used as the connection means. This looped bracket 40 contains a first hole or loop 42 through which vertical support 20 fits. As well, the looped bracket contains two (or more) holes or loops 44 and 46 through which the horizontal shaft fits. Using such a configuration connects both ends of the horizontal shaft with the respective vertical support.

The loops of the looped bracket are configured to fit around with the respective part of the device 13. In other words, the first loop 42 is configured to fit around the vertical support 20. The second and third loops 44 and 46 are configured to fit around the horizontal shaft 25. Thus, the first loop can be configured to be the same or different than the second and/or third loops. In one aspect of the invention, the second and third loops can be configured to fit differently around the horizontal shaft. This configuration could be used to provide different amounts of friction for the second and third loop with the horizontal shaft, e.g., allowing less friction for the third loop would allow more yield at that location.

The shape of the looped bracket 40 depends on the mechanical properties needed of the bracket, e.g., the strength and durability. In the looped bracket depicted in FIG. 5, the shape of the looped bracket in the area of the second and third loop is shown as rectangular. Other shapes can be used in other aspects of the invention (e.g., “u”-shapes, “v”-shapes, triangular, square, curvilinear, ellipsoidal, polygonal, etc. . . . ) that still provide the two loops in the desired configuration. The looped bracket can be made of any suitable material. Suitable materials include those that are resilient enough to not be substantially deformed during operation by the pipe supporting device 13, yet which minimize friction with the horizontal shaft 22 and the vertical support 20. Suitable materials include metal and metal alloys like steel. In one aspect of the invention, steel is used as the material for the looped bracket.

In operation, the looped bracket provides the desired connection as described above. As well, the looped bracket is extremely easy to manufacture, is inexpensive to manufacture, has a good mechanical strength, has a relatively light weight, and has the ability to prevent swiveling about the vertical support.

Having described these aspects of the invention, it is understood that the invention defined by the appended claims is not to be limited by particular details set forth in the above description, as many apparent variations thereof are possible without departing from the spirit or scope thereof.

We claim:

1. A device for supporting a pipe, comprising:
a base;
two vertical supports extending upward from the base;
a horizontal shaft located between the vertical supports; and
means for connecting the horizontal rod and the vertical supports, the connecting means comprising a looped bracket.

2. The device of claim 1, wherein the base comprises a substantially flat bottom.

3. The device of claim 1, wherein the vertical supports are mounted to the base.

4. The device of claim 1, further comprising means for positioning a pipe between the vertical supports.

5. The device of claim 3, wherein the vertical supports are supported by a plurality of flanges extend between the vertical supports and the base.

6. The device of claim 1, the connection means further comprising means for restraining the looped bracket relative to the vertical supports.

7. The device of claim 1, wherein the looped bracket contains a loop for the vertical shaft and a plurality of loops for the horizontal shaft.

8. The device of claim 7, wherein the looped bracket has a substantially rectangular shape.

9. The device of claim 7, wherein the plurality of loops is two.

10. A device for supporting a pipe, comprising:
a base;
two vertical supports extending upward from the base;
a horizontal shaft located between the vertical supports;
a looped bracket at each end of the horizontal shaft for connecting the horizontal shaft to each vertical support.

11. The device of claim 10, wherein the vertical supports are mounted to the base and supported by a plurality of flanges extending between the vertical supports and the base.

12. The device of claim 10, further comprising means for positioning a pipe between the vertical supports.

13. The device of claim 10, wherein the connection means further comprise means for restraining the looped bracket relative to the vertical supports.

14. The device of claim 10, wherein the looped bracket contains a loop for the vertical shaft and a plurality of loops for the horizontal shaft and the bracket has a substantially rectangular shape.

15. The device of claim 10, wherein the plurality of loops is two.

16. A device for supporting a pipe, comprising:
a base containing a plurality of flanges;
two vertical supports extending upward from the base and supported by the plurality of flanges;
a horizontal shaft located between the vertical supports; and
a looped bracket at each end of the horizontal shaft for connecting the horizontal shaft to each vertical support.

17. A method for supporting a pipe, the method comprising:
providing a pipe;
providing a device containing a base, two vertical supports extending upward from the base, a horizontal shaft located between the vertical supports, and means for connecting the horizontal rod and the vertical supports, the connecting means comprising a looped bracket; and
placing the pipe on the horizontal shaft between the vertical supports.

18. The method of claim 17, further comprising providing the device with positioning means for positioning the pipe between the vertical supports.

19. The method of claim 17, further comprising providing the base with a plurality of flanges for supporting the vertical supports.

20. The method of claim 17, further comprising providing the looped bracket with a loop for the vertical shaft and two loops for the horizontal shaft.
